(19) United States
(12) Patent Application Publication
(10) Pub. No.: US 2012/0212812 A1
(43) Pub. Date: Aug. 23, 2012

(54) POLARIZATION SENSITIVE FRONT PROJECTION SCREEN

(75) Inventors: Michael F. Weber, Shoreview, MN (US); Yufeng Liu, Woodbury, MN (US); Timothy J. Nevitt, Red Wing, MN (US)

(73) Assignee: 3M Innovative Properties Company, Saint Paul, MN (US)

(21) Appl. No.: 13/504,339

(22) PCT Filed: Nov. 10, 2010
(86) PCT No.: PCT/US10/56175

§ 371 Date: Apr. 26, 2012

Related U.S. Application Data
(60) Provisional application No. 61/261,888, filed on Nov. 17, 2009.

(51) Int. Cl. G03B 21/60

(52) U.S. Cl. 359/454

(57) ABSTRACT

A projection system is disclosed, in which a screen may have improved rejection of ambient light by having a high reflectivity at low angles of incidence for a polarization parallel to that of the projector, a low reflectivity at high angles of incidence for a polarization parallel to that of the projector, and a low reflectivity at both low and high angles of incidence for a polarization perpendicular to that of the projector. In some embodiments, for p-polarized light polarized parallel to the projector, the power reflectivity is high at low angles of incidence and decreases to a low value at high angles of incidence. In some embodiments, for p-polarized light polarized perpendicular to the projector, the power reflectivity is low at low angles of incidence. In some embodiments, for s-polarized light polarized perpendicular to the projector, the power reflectivity remains low at all angles of incidence. In some embodiments, the screen includes a thin film structure that has alternating quarter-wave layers of isotropic and birefringent materials, which are refractive-index-matched for light polarized perpendicular to the projector, which form a high reflector at normal incidence for light polarized parallel to the projector, and which exhibit Brewster's angle effects for p-polarized light polarized parallel to the projector at high angles of incidence. The Brewster's angle effect may be reached by use of a light-scattering layer that increases the effective incident refractive index.

### FIELD OF THE INVENTION

The present invention is directed to a screen for front projection systems.

### BACKGROUND

Front projection systems have been around since the 1800s, in which an image is projected onto a screen, and the viewer sees the light reflected from the screen.

Typical front projectors have evolved from theatrical film projectors, home movie projectors, education filmstrip projectors, slide projectors and overhead transparency projectors, through today's LCD-based projectors, with many variations along the evolutional path.

The screens that accompany these projectors have also evolved over time. Presumably, the first projectors were projected onto a wall. The light reflected from the wall was largely specularly reflected, with too much light contained in the specular reflection, and not enough light scattered into other reflected angles. Early screens were an improvement over merely projecting onto the wall; in that a dedicated screen could incorporate a roughened surface or some other suitable structure for scattering the reflected light into a range of exiting angles, allowing for a relatively wide range of viewing angles.

Even as the screens have evolved over the years, many screens still suffer degradation in performance due to ambient light.

For instance, a typical front-projection screen 1 is shown in FIG. 1. A projector 3 projects light onto the screen 1 and forms an image at the screen 1. As a viewer watches the image, light from the projector 3 reflects off the screen and enters the eye of the viewer 2; this light may be referred to as “image” light.

In addition to the “image” light that leaves the projector 3 and arrives at the viewer 2, there is so-called “non-image” light, which is generated by a source other than the projector 3. For instance, an overhead light 4 may generate ambient light, which can reflect off the screen and arrive at the viewer 2. Or, light from the sun 5 may enter through a window 6, reflect off the screen, and arrive at the viewer 2. This “non-image” light appears as a background light level across all or most of the image, which can erode the contrast of the image and make the image appear washed-out.

The performance of the typical screen 1 of FIG. 1 is shown in the plot of FIG. 2, which is a plot of the screen's power reflectivity as a function of incident angle. In general, the reflectivity of a typical screen is fairly high over a large range of incident angles. “Image” light from the projector 3 strikes the screen at a relatively low angle of incidence, since the projector is typically oriented for normal incidence or near-normal incidence. In contrast, “non-image” light from an overhead room light 4 or a window 6 strikes the screen at a relatively high angle of incidence. The typical screen 1 reflects both the “image” and “non-image” relatively well, and as a result, the ambient light is mixed in with the image light and degrades the contrast of the image.

Accordingly, there exists a need for a front-projection screen which can reject all or a portion of the non-image light, so that the contrast of the image may remain high and the quality of the projected image may be made less sensitive to ambient light.

### BRIEF SUMMARY

An embodiment is a front projection system, comprising: a projector for projecting light to a screen, the light having a first polarization state; a screen for receiving the light from the projector and reflecting light to a viewer, the screen comprising: an absorber; and a film disposed adjacent the absorber, between the absorber and the projector, the film having: a high power reflectivity at low angles of incidence for the first polarization state, a low power reflectivity at high angles of incidence for the first polarization state, a low power reflectivity at low angles of incidence for a second polarization state perpendicular to the first polarization state, and a low power reflectivity at high angles of incidence for the second polarization state.

A further embodiment is a screen having a viewing side for receiving linearly polarized projected light with a projection polarization orientation from a projector and reflecting light to a viewer, comprising: a light-scattering layer comprising a plurality of transmissive partial spheres and providing an elevated effective incident refractive index, the elevated effective incident refractive index depending at least on a depth and a refractive index of the transmissive partial spheres; and a thin film structure disposed adjacent the light-scattering layer opposite the viewing side and including a plurality of alternating first and second layers. Each first layer is birefringent and has a first refractive index, for light polarized along the projection polarization orientation and a second refractive index, for light polarized perpendicular to the projection polarization orientation. Each second layer is isotropic and has an isotropic refractive index, matched to the second refractive index and mismatched from the first refractive index. P-polarized light incident on the viewing side of the screen at at least one incident angle experiences a reduced reflectivity due to Brewster's angle effects at interfaces between the alternating first and second layers.

A further embodiment is a method, comprising: providing an array of partial spheres disposed on a substrate, the substrate having a surface normal; directing an initial light ray onto the array of partial spheres at a non-zero initial incident angle with respect to the substrate surface normal; refracting the initial light ray at the surface of the partial spheres to form an intra-sphere light ray; transmitting the intra-sphere light ray through the partial spheres; and transmitting the intra-sphere light ray into the substrate to form an intra-substrate light ray propagating at a substrate refracted angle with respect to the substrate surface normal. The substrate refracted angle is greater than a critical angle for the substrate in air.

### BRIEF DESCRIPTION OF THE DRAWINGS

FIG. 1 is a schematic drawing of a known front projection system.

FIG. 2 is a plot of the screen power reflectivity for the known front projection system of FIG. 1.

FIG. 3 is a plot of the screen power reflectivity for an exemplary front projection system.

FIG. 4 is a schematic drawing of the screen power reflectivity, for various polarization orientations and incident angles and propagation orientations, for the screen of FIG. 3.

FIG. 5 is a schematic drawing of the orientations of incident and reflected light rays from the screen of FIG. 3.

FIG. 6 is a schematic drawing of the incident and refracted light rays from the light-scattering layer of the screen of FIG. 3.

FIG. 7 is a schematic drawing of the mathematical quantities used for the light-scattering layer of FIG. 6.

FIG. 8 is a plot of the transmitted angle in the interior of the light-scattering layer of FIG. 6, calculated in a statistical (raytracing) manner, and calculated with a modified version of Snell's Law and an elevated effective incident refractive index.

FIG. 9 is a side view of an exemplary thin film structure.

FIG. 10 is another side view of the exemplary thin film structure of FIG. 9, orthogonal to the view of FIG. 9.

FIG. 11 is a plot of the simulated power reflectivity of the thin film structure of FIGS. 9 and 10.

FIG. 12 is a side view of a second exemplary thin film structure.

FIG. 13 is another side view of the exemplary thin film structure of FIG. 12, orthogonal to the view of FIG. 12.

FIG. 14 is a plot of the simulated power reflectivity of the thin film structure of FIGS. 12 and 13.

FIG. 15 is a side view of a third exemplary thin film structure.

FIG. 16 is another side view of the exemplary thin film structure of FIG. 15, orthogonal to the view of FIG. 15.

FIG. 17 is a plot of the simulated power reflectivity of the thin film structure of FIGS. 15 and 16.

FIG. 18 is a plot of the simulated power reflectivity of the thin film structure of FIGS. 15 and 16, when used without the light-scattering layer.

FIG. 19 is an embodiment of a light-scattering layer.

FIG. 20 is another embodiment of a light-scattering layer.

FIG. 21 is another embodiment of a light-scattering layer.

FIG. 22 is another embodiment of a light-scattering layer.

### DETAILED DESCRIPTION OF ILLUSTRATIVE EMBODIMENTS

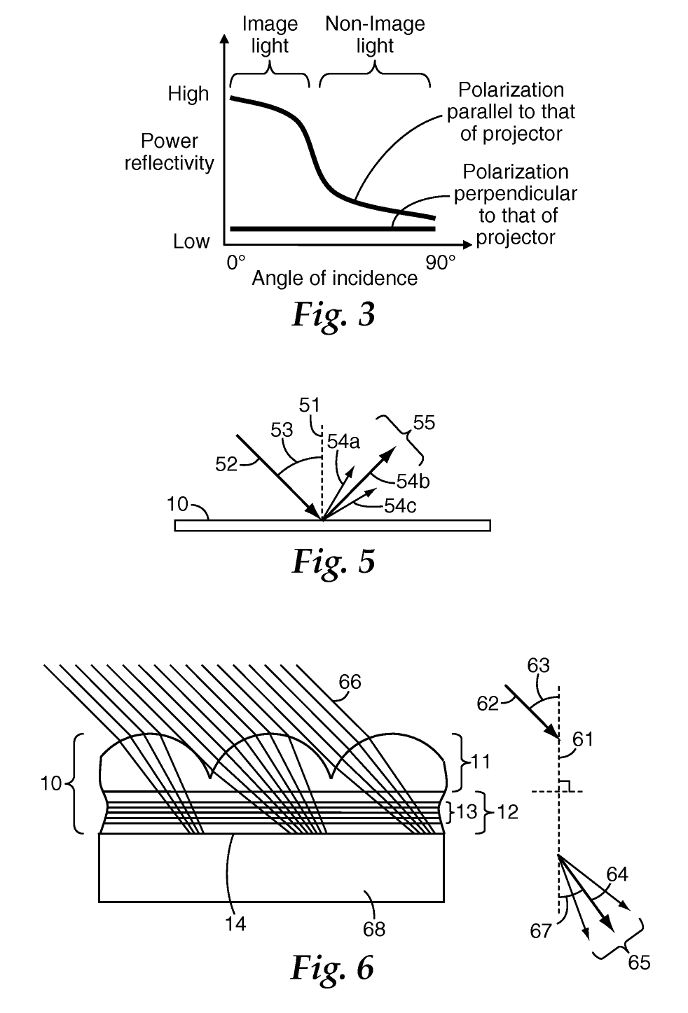

There exists a need for a front-projection screen that has a reduced sensitivity to ambient light. Such a screen is shown in generalized form in FIGS. 3-5, then in more detail in the figures and text that follow.

It is instructive to briefly review the inner workings of a typical modern projector. This description of the projector is merely exemplary, and should not be construed as limiting in any way.

In one type of projector, light from a source is collected by a condenser and directed onto a pixilated panel, such as a liquid crystal on silicon (LCOS) panel. The light reflected from the pixilated panel is then imaged onto a distant screen by a projection lens. In this type of projection system, the pixilated panel is generally tiny, compared to the viewable image on the screen, and it is generally considered desirable to situate the source, the condenser, the pixilated panel, and the intervening optics (excluding the projection lens) in the smallest possible volume with the fewest number of components.

Typically, the pixilated panel relies on polarization effects to perform its pixel-by-pixel attenuation, and is effectively situated between two polarizers (or, equivalently, operates in reflection adjacent to a single polarizer). As a result, the output from this type of projector is typically linearly polarized. Depending on the projector design, the projector output light may have a polarization orientation that is horizontal, vertical, or any particular orientation between horizontal and vertical.

Because the projector output light may be polarized, it may be beneficial for the screen to have a low reflectivity for light polarized perpendicular to that of the projector. All such light would arise from a source other than the projector, and may be considered “non-image” or ambient light.

For light polarized parallel to that of the projector, it may be beneficial to consider two regimes. A first regime is light striking the screen at a low angle of incidence, which would correspond to light coming from the projector. This may be considered “image” light. A second regime is light striking the screen at a high angle of incidence, which would arise from a source other than the projector, such as a room light or light from a window. This may be considered “non-image” light.

FIG. 3 shows an exemplary desired performance of the screen, for these cases of polarization orientation and incident angle. Light from the projector strikes the screen at a generally low angle of incidence, with a particular polarization orientation; it is desirable for the screen to have a high reflectivity for this projector light, and have a low reflectivity for all other light.

Ideally, in some applications, the “parallel” curve has as high a reflectivity as possible for “low” angles of incidence, has as low a reflectivity as possible for “high” angles of incidence”, and has as sharp a transition as possible between the “low” and “high”-angle portions. “High” power reflectivity may ideally approach 100%, “low” power reflectivity may ideally approach 0%, and the distinction between “high” and “low” may occur at a particular incident angle, such as 20 degrees, 25 degrees, 30 degrees, 35 degrees, 40 degrees, 45 degrees, or any suitable value, depending on the projection optics and screen geometry.

These values of “high” and “low” power reflectivity are idealized, and in practice, a real screen may have less than 100% and greater than 0% power reflectivity. In practice, it may be sufficient for a “high” power reflectivity to exceed a particular value over a particular angular range, and for a “low” power reflectivity to be less than a particular value over a particular angular range. For instance, a “high” power reflectivity may be greater than 70%, 75%, 80%, 85%, 90%, 92%, 95%, 98%, 99%, 99.5%, or any other suitable value. Similarly, a “low” power reflectivity may be 30%, 25%, 20%, 15%, 10%, 5%, 2%, 1%, 0.5%, or any other suitable value.

Note that the “high” and “low”-power angular ranges need not be strictly adjacent, but may be separated by an angular buffer, in which the reflectivity transitions from “high” to “low”. For instance, the “high” and “low”-power angular ranges may be separated by 0 degrees, 0.5 degrees, 1 degree, 2 degrees, 5 degrees, 10 degrees, 15 degrees, 20 degrees, or any other suitable value.

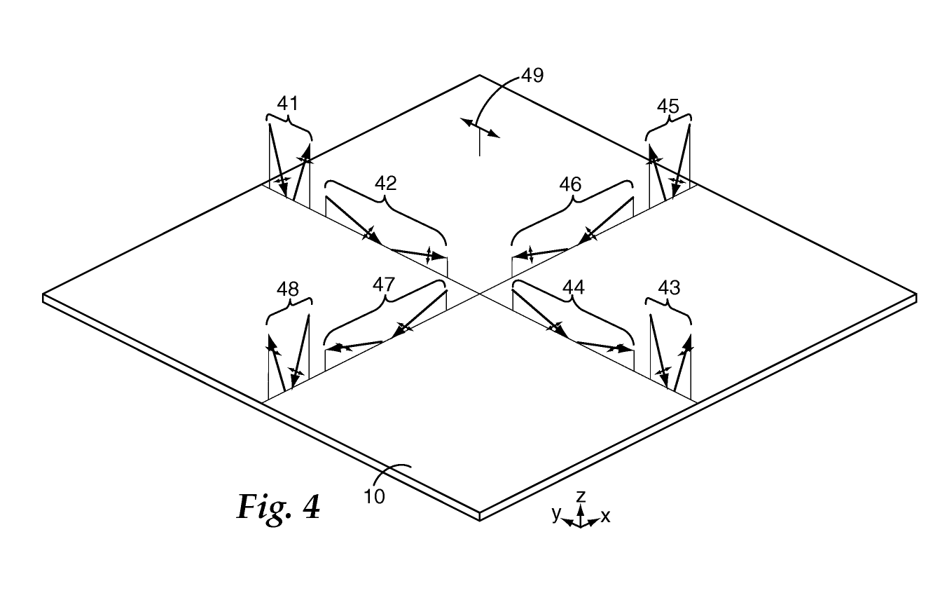

For one application of a screen 10, the power reflectivity performance of FIG. 3 is summarized in the schematic drawing of FIG. 4.

The projector emits light with a polarization state oriented along direction 49. So-called “image light” is light that strikes the screen 10 at low angles of incidence with a polarization state parallel to that of the projector. All other light may be referred to as “ambient” or “non-image” light. It is desirable, and may be considered a design goal, for the screen 10 to have a high reflectivity for “image” light, and a low reflectivity for “non-image” light.

FIG. 4 shows the geometry of the “image” and “non-image” light, with respect to projector polarization 49 and the screen 10. In general, light striking the screen may have any incident angle between 0 and 90 degrees, and may have any polarization state. We consider eight representative cases of incident light for FIG. 4, with each case having a unique combination of low and high incident angles, p- and s-polarization, and planes of incidence that are parallel and perpendicular to the projector polarization 49. In general, any arbitrary incident beam may be decomposed into a combination of these eight representative beams, so that the full performance of the screen 10 may be sufficiently expressed in terms of these eight beams.

Beams 41, 43, 45 and 48 have a relatively low incident angle. Beams 42, 44, 46 and 47 have a relatively high incident angle. Beams 41, 42, 45 and 46 are p-polarized. Beams 43, 44, 47 and 48 are s-polarized. Beams 41, 42, 43 and 44 have a plane of incidence that is parallel to the projector polarization 49. Beams 45, 46, 47 and 48 have a plane of incidence that is perpendicular to the projector polarization 49.

Light that emerges from the projector has a polarization orientation 49, and strikes the screen 10 at a relatively low angle of incidence. FIG. 4 shows that beams 41 and 48 may represent this “image” light that emerges from the projector. In general, it is desirable for the screen 10 to have a relatively high power reflectivity (“R”) for “image” light, so that light leaving the projector arrives at the viewer with relatively low losses.

All other light that strikes the screen, including beams 42, 43, 44, 45, 46 and 47, may be considered “non-image” light. This may include ambient light from other light sources, such as room lights, or outside light from windows. In general, it is desirable for the screen 10 to have a relatively low power reflectivity for “non-image” light, so that “non-image” light may be kept out of the light directed to the viewer, as much as possible.

Therefore, for a screen 10 for which the projector and viewer are both oriented fairly close to normal incidence, it is desirable to have power reflectivity (R) high for beams 41 and 48, and low for beams 42-47. In practice, producing a desired value of R may be easier for some of the eight beams than for others; this is explored further in the text that follows.

Note that there may be some projector designs in which the polarization may not be oriented in the same direction for all colors in the spectrum. For instance, the projector may use light from three colored sources, such as red, green and blue, and may rely on polarization-sensitive beamsplitting optics to combine the light from the three sources. As a result, the polarization state of one color may be perpendicular to the polarization states of the other two colors.

One approach for treating this discrepancy of the polarization state of one color is to place after the projector a polarization rotator that operates in the spectral region of one of the colors but has a negligible effect on the other two colors. Such a polarization rotator would reorient the polarization of that particular color by about 90 degrees to coincide with the polarization of the other two colors, so that all three polarizations would be parallel for light leaving the rotator. Such a color-sensitive polarization rotator is known, and is sold by vendors such as ColorLink®, based in Boulder, Colo. Such a color-sensitive polarization rotator may be manufactured by sandwiching thin polymer films between antireflection-coated glass substrates, or by any other suitable method. Alternatively, a half-wave plate (or retarder) may be used at a suitable angle, to “flip” the linear polarization state of one particular color. In some applications, such a retarder may be approximately achromatic over the wavelength range of the particular color, and may have close to zero retardance in the wavelength ranges of the other two colors.

FIGS. 3 and 4 show the intensity performance, or power reflectivity performance of an exemplary screen 10, which essentially answers the question, “How much of a particular light beam is reflected?” for a particular beam orientation and polarization state.

FIG. 5 shows the expected direction of the reflected beam, and essentially answers the question, “What direction does the reflected beam have?”

The screen 10 may have one or more diffusers or light-scattering layers, which may scatter an incident light ray into a range of reflected angles. The diffuser or light-scattering layer may have features that are smaller than the spatial extent of a pixel of the incident beam, so that while a particular (x,y) location on each tiny feature may direct a reflected or refracted ray in a deterministic manner, the sum effect of all of these (x,y) locations is to form a probabilistic distribution of reflected or refracted rays.

For instance, FIG. 5 shows an incident ray 52 on a screen 10. The incident ray 52 forms an incident angle 53 with respect to a surface normal 51. The surface normal 51 and the incident ray 52 form a plane of incidence, which is the plane of the page in FIG. 5. The effect of the light-scattering layer(s) is to produce a range 55 of exiting or reflected angles. The range may have a probabilistic distribution, such as a distribution with a mean value and a standard deviation, corresponding to the distribution of reflected light into various directions. For example, reflected ray 54b may represent the mean direction, while rays 54a and 54c may represent the mean+/−the standard deviation direction. Physically, this means that more light is traveling along direction 54b than along direction 54a or direction 54c.

In some applications, the ray 54b may represent the specular reflection from the screen 10, where the angle of reflection equals the angle of incidence and the specularly reflected ray 54b remains in the plane of incidence.

FIG. 5 may be beneficially illustrated with a numerical example. An exemplary light-scattering layer on the screen 10 may operate so that incident light, having an incident angle of 20 degrees, may be reflected in a distribution having a reflected angle of 20 degrees+/−5 degrees. Other distribution widths may include, for instance, +/−10 degrees, +/−15 degrees, +/−20 degrees, +/−25 degrees, +/−30 degrees, +/−40 degrees, +/−50 degrees, +/−60 degrees, +/−70 degrees, or any other suitable value. The central value of the distribution, 20 degrees in this example, may be the mean value of the distribution, the median value of the distribution, or any other suitable value. Other distribution central values may include, for example, 5 degrees, 10 degrees, 15 degrees, 25 degrees, 30 degrees, 40 degrees, 50 degrees, 60 degrees, 70 degrees, or any other suitable value.

The edges of the distribution, 15 degrees and 25 degrees in this example, may be the +/−1-standard-deviation values, or the 1-standard-deviation values multiplied by a numerical constant such as 0.5, 1, 2, 3 and so forth. They may alternatively be the full-width-at-half-max points, the 1Q and 3Q distribution points, or any other suitable width. In general, the width of the reflected light distribution is determined in part by the feature size and shape of the light-scattering layer.

Note that the light-scattering layer may also direct rays out of the plane of incidence, or out of the plane of the page in FIG. 5. There may be an angular distribution associated with this out-of-plane orientation, which may or may not be equal to the angular distribution within the plane.

In some applications, the diffuser or light-scattering layer may be a relatively mild scatterer, which may deflect the reflected light by only a few degrees. In contrast, a relatively strong diffuser may deflect the reflected light into a full 2π steradians. These strong diffusers may be appropriate for applications such as light integrating spheres, but may not be suitable for some applications of the screen 10. The relatively mild scatterer may be sufficient to blur out the specular reflection, so that a viewer looking at the screen in the exact orientation of the specular reflection may be spared from seeing an extremely high intensity in the image.

It in instructive to summarize the general requirements of the screen 10 thus far. In some applications, the screen has a high reflectivity at low angles of incidence for a polarization parallel to that of the projector (beams 41 and 48), a low reflectivity at high angles of incidence for a polarization parallel to that of the projector (beams 42 and 47), and a low reflectivity at both low and high angles of incidence for a polarization perpendicular to that of the projector (beams 43, 44, 45 and 46). For a plane of incidence parallel to the projector polarization, one application of the screen has a high reflectivity at low angles of incidence for p-polarized light (beam 41), a low reflectivity at high angles of incidence for p-polarized light (beam 42), and a low reflectivity for s-polarized light (beams 43 and 44). For a plane of incidence perpendicular to the projector polarization, one application of the screen has a high reflectivity at low angles of incidence for s-polarized light (beam 48), a low reflectivity at high angles of incidence for s-polarized light (beam 47), and a low reflectivity for p-polarized light (beams 45 and 46). In some applications, the screen 10 has one or more light-diffusing layers, which direct reflected light into a range of reflected angles, both within and out of the plane of incidence. In some applications, the reflected range may include the specular reflection. FIGS. 6-18 are directed to specific applications of such a screen 10.

FIG. 6 is a schematic diagram of one application of a screen 10. A light-scattering layer 11 faces both the projector and the viewer (neither shown in FIG. 6), and is attached to or made integral with a substrate 12 that includes a thin film structure 13. There is an absorber or absorbing layer 14 also attached to or made integral with the substrate 12, opposite the light-scattering layer 11. There may be an optional support substrate 68 on the side opposite the absorber 14.

Light enters the screen 10 through the light-scattering layer 11 and then enters the substrate 12. The thin film structure 13 produces a high reflectivity for certain polarizations and certain propagation directions, and light reflecting with this high reflectivity exits the substrate 12, transmits through the light-scattering layer 11, and exits the screen 10 on the side facing the viewer. For polarizations and propagation directions that do not have a high thin film reflectivity, light transmits through the thin film structure 13 and is absorbed by the absorbing layer 14. In general, the thin film structure itself may be made from transparent, non-absorbing (dielectric) materials.

In general terms, the thin film structure 13 may provide a reduced reflectivity for conditions analogous to a Brewster's angle condition, for rays with particular propagation and polarization orientations. Such a propagation orientation may be difficult to achieve for a thin film structure 13 if situated inside a purely planar media structure with air incidence, because the propagation angle inside the thin film structure may exceed the critical angle. In other words, if the thin film structure 13 were used in a purely planar media structure with air incidence, the Brewster's angle condition inside the thin film structure 13 might require the physical and mathematical impossibility of an air incident angle larger than 90 degrees. Alternatively, in some cases, the Brewster's angle in the thin film structure 13 may indeed be accessible with an incident angle in air of less than 90 degrees.

As a result, the thin film structure 13 may be located adjacent to a light-scattering layer 11, which may increase the angle of propagation inside the thin film structure 13 for a particular incident angle. This may allow the Brewster's angle condition to be reached inside the thin film structure 13 for an angle of incidence in air (with respect to the substrate surface normal) of less than 90 degrees, which is both physically and mathematically possible.

The above two paragraphs are merely summaries of the functions of the light-scattering layer 11 and the thin film structure 13. Both of these structures are described in considerably greater detail below.

The following paragraphs describe the structure and function of the light-scattering layer 11.

In general, the light-scattering layer 11 has the effect of receiving incident light rays, and transmitting refracted light rays. For relatively large beams that subtend one or more features along the surface of the light-scattering layer 11, the relationship between incident angle and exiting angles becomes probabilistic, rather than deterministic. For instance, a relatively large number of rays may be directed into one principal angle, with a relatively smaller number of rays being directed into angles away from that principal angle.

In the schematic drawing of FIG. 6, consider a collection of light rays 66 incident on the screen 10. The light rays travel in air along a representative incident direction 62, and form a particular incident angle 63 with respect to a substrate surface normal 61. This incident angle 63 is not the physical incident angle of a particular ray on the surface of the light-scattering layer 11, but is what the incident angle would be if the screen were locally flat. Note that the collection of incident rays 66 need not be parallel.

As a result, for a particular incident ray orientation 62, with associated incident angle 63 (formed with respect to the substrate surface normal 61), the refracted light rays may have a probabilistic distribution, described by a representative direction 64 having a representative refracted angle 67, and a range 65 of refracted angles. In general, for the light exiting the light-scattering layer 11, more light travels along the representative direction 64, and less light travels along the directions at the edges of the range 65. The range may or may not be symmetrical, and may or may not be centered around the representative direction 64.

The benefits of this probabilistic relationship are two-fold. First, the representative refracted angle 67 may be larger than what one would achieve if the light-scattering layer 11 were replaced by a planar structure, for a particular incident angle 63. In this manner, the light-scattering layer may allow particular propagation directions inside the thin film structure 13 that might otherwise be difficult or impossible to achieve with a purely planar media structure. The second benefit is that because a particular incident angle produces a finite range 65 of refracted angles, which reflects off the thin film structure 13 and transmits through the light-scattering layer 11a second time, the light-scattering layer may therefore help diffuse the specular reflection off the screen 10.

The relationship between incident angle 63 and representative exiting angle 67 may be approximated by a modified version of Snell's Law, which, for planar interfaces, dictates that the product of the refractive index and the sine of the propagation angle (with respect to the substrate surface normal) is constant for each layer in the interface. This modified version of Snell's Law treats the light-scattering layer as being planar, with an “effective” refractive index for the incident medium that can vary between 1 and the refractive index of the light-scattering layer material, depending on the geometry of the curved features on the surface of the light-scattering layer. In general, the deeper the curved features (or, equivalently, the closer the curved features are to hemispheres), the higher the “effective” incident refractive index. Likewise, the more shallow the curved features (or, equivalently, the closer the curved features are to a planar surface), the lower the “effective” incident refractive index. Note that this approximation addresses the representative propagation angle 67, but not the range 65 of propagation angles.

A benefit of such an approximation is that once an effective incident refractive index is determined for a particular geometry, then the relationships between incident angle 63 and propagation angle 67 (both with respect to the substrate surface normal 61) are easily determined from Snell's Law, which states that the product of the refractive index and the sine of the propagation angle is constant across an interface. For our example, the incident refractive index is the effective value, the transmitted refractive index is the refractive index of the light-scattering layer, and the incident and transmitted propagation angles 63 and 67 are with respect to the substrate surface normal 61, as shown in FIG. 6.

The effective refractive index may be 1.0, 1.05, 1.1, 1.15, 1.18, 1.2, 1.25, 1.3, 1.35, 1.4, 1.45, 1.5, or any other suitable value. Alternatively, the effective refractive index may be in the ranges of 1-1.5, 1.1-1.3, or 1.15-1.25. Any other suitable ranges may be used as well.

An additional benefit of the “effective” refractive index approximation is that the “effective” incident refractive index may be used as a variable during the design of the thin film structure 13. Once a design has settled on a desired “effective” incident refractive index, the geometry of the curved features may be adjusted until the “effective” incident refractive index is achieved.

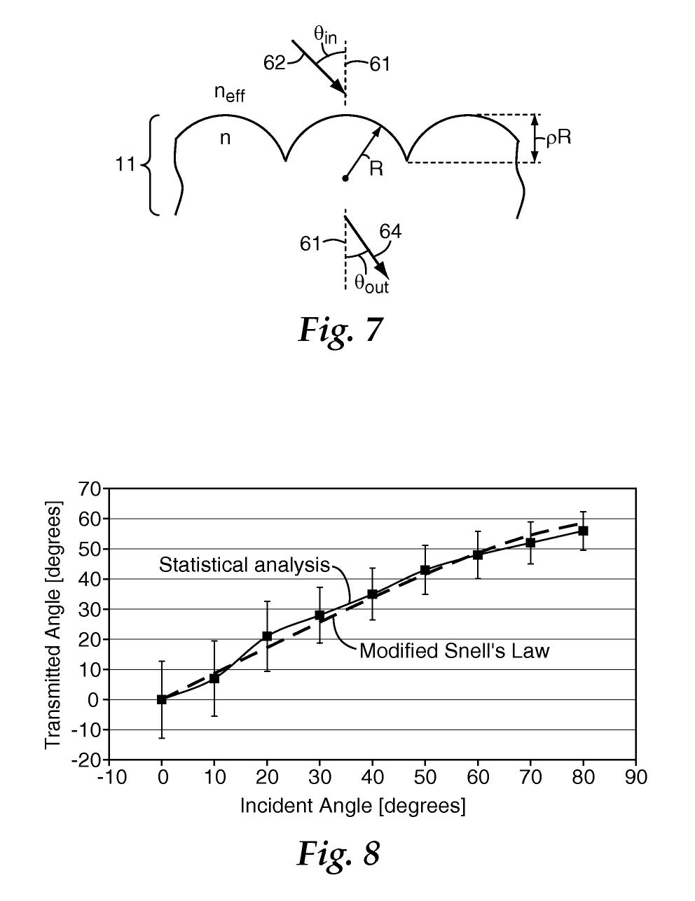

FIG. 7 shows the mathematical quantities used for some applications of the light-scattering layer 11. The light-scattering layer 11 is made from a material having a refractive index denoted by n, which typically falls in the range of about 1.4 to about 1.9.

A refractive index n of 1.5 is typical. The light-scattering layer 11 includes an array of partial spheres, each with a radius R and a depth of ρR. The dimensionless quantity ρ can vary from 0, at which the sphere features have essentially no depth and the light-scattering layer is essentially planar, to 1, at which the sphere features are essentially all hemispheres. The effective incident refractive index n_{eff} may be determined from a raytracing simulation, and depends on the refractive index n and depth dimensionless quantity ρ. This dependence may be written as:

n_{eff}=n_{eff}(n,ρ)

Once n_{eff} is determined, Snell's Law may be used to approximately predict the exiting angle θₒᵤₜ of a representative ray 64, for an arbitrary incident ray 62 having an angle of incidence θᵢₙ. Note that Snell's Law may be considered “modified” in that the angles of incidence and exitance are taken with respect to the substrate surface normal 61, rather than the actual, local surface normal, which depends on (x,y) location and varies across the surface of the spherical features. This “modified” Snell's Law relates the incident and exiting angles, θᵢₙ and θₒᵤₜ, to the real refractive index of the light-scattering layer, n, and the effective incident refractive index n_{eff} as follows:

n_{eff} sin θᵢₙ=n sin θₒᵤₜ

A comparison between a statistical raytrace analysis and the corresponding Modified Snell's Law prediction is shown in FIG. 8, for a typical light-scattering layer refractive index of 1.5 and a depth dimensionless quantity of 0.8. The transmitted angles are given for a range of incident angles from 0 degrees to 80 degrees. The plots in FIG. 8 show an excellent agreement between the Snell's Law predicted value (dashed), and the value of the representative ray calculated in a statistical manner using raytracing (solid).

The statistical data points show a range of transmitted angles, such as 0 degrees+/−12 degrees. This range is consistent with the range 65 of angles shown in FIG. 6, and the data may be interpreted as follows. For an incident angle of 0 degrees, the most “common” transmitted angle is 0 degrees, meaning that the most optical power is propagating with an angle of 0 degrees. Compared to 0 degrees, less optical power is propagating at other angles, within a range of +/−12 degrees. Note that the range of transmitted angles decreases at high incident angles. Note also that the range of transmitted angles need not be centered on the representative transmitted angle value, but may optionally be asymmetric about this value.

The statistical analysis may be performed by any suitable raytracing program, such as Zemax, Oslo, Code V, ASAP, and so forth. The results do not depend strongly on the packing arrangement of the sphere portions on the surface. In other words, the spheres may be packed in a triangular, rectangular, hexagonal, or any other suitable array without significantly affecting the calculated effective incident refractive index.

The raytracing calculations that produced the results of FIG. 8 may be repeated at any other refractive index and depth. For a refractive index of 1.5, depth dimensionless quantities ρ of 1, 0.8 and 0.2 yield effective incident refractive indices of about 1.30, 1.30 and 1.18, respectively. Other combinations of refractive index and depth may be calculated as well in a straightforward manner.

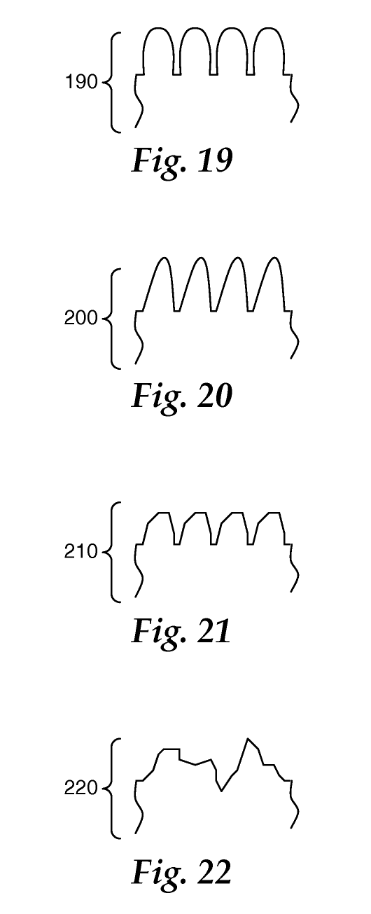

Note that other shapes and geometries may be used in addition to, or instead of the partial spheres shown in FIGS. 6 and 7. For instance, FIG. 19 shows a light-scattering layer 190 that includes a non-spherical curved profile, which may be a conic and/or an asphere, or neither. As another example, FIG. 20 shows a light-scattering layer 200 that includes a skewed profile. As a further example, FIG. 21 shows a light-scattering layer that includes a skewed profile that includes one or more straight portions. Finally, FIG. 22 shows a light-scattering layer 220 that includes a jagged, non-repeating pattern. This jagged profile includes generally straight portions, although it may optionally include only curved portions, or may be a mixture of both straight and curved portions. It will be understood that many other suitable profiles may be used in the light-scattering layer, such as a repeating feature that alternates with a different repeating feature (i.e., every other feature repeats), a mixture of curved and straight portions, a feature that changes over the area of the screen, such as a feature height or a particular curvature, a feature-to-feature spacing that changes over the area of the screen, a blazed feature such as an asymmetric sawtooth, and so forth. In general, any other surface then can result in a larger effective refractive index.

Ultimately, it is the probability distribution of surface normals that determines the effective incident refractive index properties of the light-scattering layer. If two light-scattering layers made from the same material have the same surface normal distributions, then they may perform similarly when used to increase the effective incident refractive index of the optical system.

In summary, the function of the light-scattering layer may be as follows. First, the light-scattering layer may provide a diffusing effect to a relative large reflected or transmitted beam that subtends several of the light-scattering features, which shows up mathematically as a non-zero range of reflected or transmitted angles, for a single incident angle. Second, the light-scattering layer may alter the propagation directions of transmitted light to extend beyond those that would be attainable from a purely planar, air-incident structure. This extension shows up mathematically as an “effective” incident refractive index greater than 1, which may be used in a modified version of Snell's Law that relates incident and exiting angles with respect to a substrate surface normal. The effective incident refractive index depends on the true refractive index of the light-scattering layer and the geometry of the light-scattering features. For a light-scattering layer with a refractive index of 1.5, partially spherical features with depths in the range of 20% to 80% of a hemisphere yield effective incident refractive indices in the range of about 1.18 to about 1.30.

When used in combination with a thin film structure 13, the light-scattering layer 11 may allow light to propagate at higher propagation angles inside the film structure 13 than what would be physically possible with a purely planar, air-incident structure. In terms of a numerical example, the value of (n sin θ) inside the thin film structure 13 may rise by an amount in the range of about 18% to about 30%, due to the addition of the light-scattering layer.

The following paragraphs describe the structure and function of the thin film structure 13.

A design goal for the screen 10 is to have a high reflectivity for light from the projector, and a low reflectivity for everything else. The output from the projector is typically linearly polarized, and light from the projector typically strikes the screen 10 at low angles of incidence, so it is a reasonable goal to have a high reflectivity at low angles of incidence for light polarized parallel to the projector output, and a low reflectivity for everything else.

In some applications of the screen 10, the thin film structure 13 is made from non-absorbing materials, so that light not reflected from the thin film structure 13 is transmitted through the thin film structure 13 and is absorbed by a dedicated absorber 14. In these applications, it is sufficient to examine the reflectivity properties of the thin film structure itself to determine the reflectivity properties of the whole screen 10.

In some applications, the thin film structure 13 may be encased in a protective shell, may be laminated to or grown on one or more protective layers, or may be made integral with one or more protective layers. In these applications, the protective shell and the thin film structure together make up the substrate 12. Typically, the protective layers in the substrate 12 on either or both sides of the thin film structure 13 are optically thick, meaning that light reflected from both sides of each protective layer adds incoherently. In other words, there is essentially no constructive or destructive interference arising from reflections originating from the outward faces of the substrate; the only coherent interference effects arise from the thin film structure 12 itself. Typically, the protective layers are refractive-index matched to their respective adjacent layers in the thin film structure 13, to reduce the reflections arising from the interface between the protective layer and the thin film structure 13. Note that the substrate 12 may simply be the thin film structure 13 itself, without any additional protective layers.

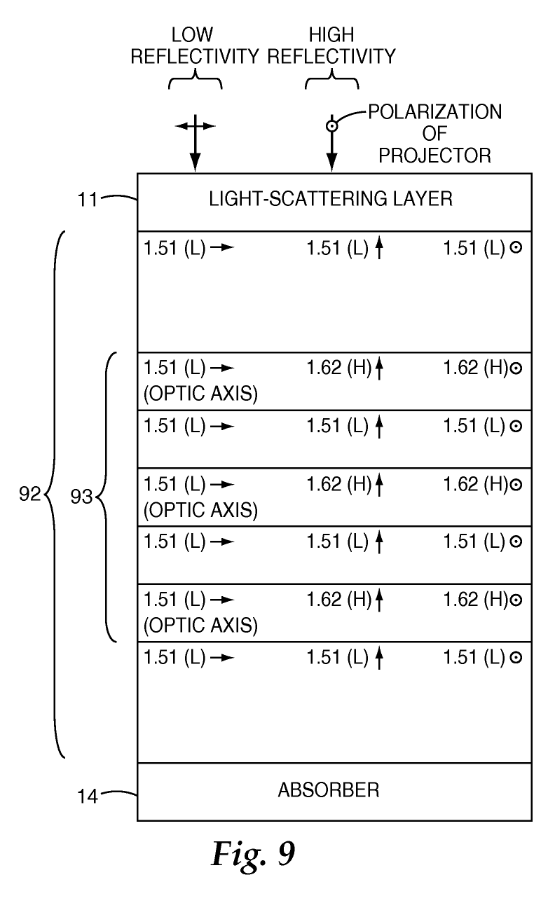

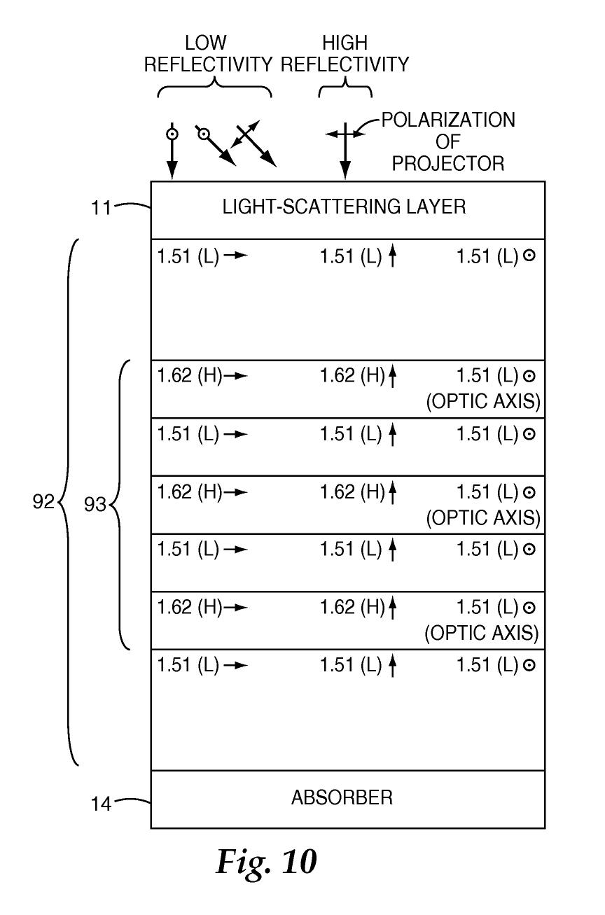

FIGS. 9 and 10 are schematic drawings of a typical thin film structure 93. Both FIGS. 9 and 10 show the same thin film structure 93, but viewed from orthogonal directions. Light enters the screen on the side facing the viewer (from the top of FIGS. 9 and 10), passes through the light-scattering layer 11, enters the substrate 92 and enters the thin film structure 93. Light transmitted through the thin film structure 93 exits the substrate 92 and enters the absorber 14, where it is absorbed. Light reflected from the thin film structure 93 exits the substrate 92, passes through the light-scattering layer 11 and exits the screen 10 on the side facing the viewer. The thin film structure 93 is drawn as having five layers, but typical thin film structure may have many more layers, such as 50, 100, 150, 200, 250, 300, 350, 400, 500, 700, 1000 or any suitable value.

The thin film structure 93 relies on polarization and interference effects to achieve a relatively high reflectivity for the projector light (low angles of incidence for the polarization state parallel to that of the projector—see top right of FIG. 9 and top right of FIG. 10) and a relatively low reflectivity for everything else (high angles of incidence for the polarization state parallel to that of the projector—see top left of FIG. 10).

The thin film structure 93 includes a stack of alternating materials, typically with one material having a relatively high refractive index and being denoted as “high” or “H”, and the other material having a relatively low refractive index and being denoted as “low” or “L”. Either or both of the materials in the stack may be birefringent, and depending on the orientation of the optic axis of the birefringent material, a particular material may be “H” for one polarization state and “L” for the orthogonal polarization state.

For the applications of FIGS. 9 and 10, each pair of layers includes a birefringent layer that has a refractive index of about 1.62 (“H”) for one polarization state and a refractive index of about 1.51 (“L”) for the orthogonal polarization state, and a non-birefringent layer having a refractive index of about 1.51 (“L” for both polarization states).

The optical thickness of each layer is a quarter-wave. High reflectivity is achieved by constructive interference of the reflections arising from each high-low interface; each reflection may be relatively small, such as 0.1% in power, but the combined effect of the constructive interference arising from many of these small reflections can result in a relatively high power reflectivity, such as 90%, 95%, 98%, 99%, 99.5%, 100% or any suitable value.

The physical thickness of each layer depends on the wavelength and incident angle at which the layer is to have a quarter-optical wave thickness. If the layers are to have a quarter-wave optical thickness at normal incidence at a particular wavelength, then the physical thickness of each layer is given by (the wavelength)/(4n), where “n” is the refractive index of the particular layer at the wavelength. Any suitable wavelength may be used in the visible spectrum, between 400 nm and 700 nm, although wavelengths in the green region of the spectrum, such as 500 nm or 550 nm are most common. The “H” and “L” layers may have refractive indices of 1.62 and 1.51, respectively, although other suitable values may be used.

For some thin film structures in which all “H” layers have the same thickness and all “L” layers have the same thickness, the spectral reflectivity profile may be unacceptably narrow. Such a quarter-wave thin film stack may operate well at one particular design wavelength, but may perform poorly outside of a small wavelength range. The operating wavelength range may be increased by varying the thicknesses of the “H” and “L” layers, as follows.

In some applications, the individual “H” and “L” layers may have varying thicknesses from the top to the bottom of the thin film structure. For instance, an “H” layer near one side of the thin film stack may have a different thickness than an “H” layer near the opposite side of the thin film stack. Likewise, an “L” layer near one side of the thin film stack may have a different thickness than an “L” layer near the opposite side of the thin film stack. More specifically, one side of the thin film stack may be tuned to one wavelength, such as 400 nm, where the “H” and “L” layers are both a quarter-wave thick at 400 nm, while the opposite side of the thin film stack may be tuned to a different wavelength, such as 700 nm, where the “H” and “L” layers are both a quarter-wave thick at 700 nm. The optical thickness of the “H” and “L” layers may vary in discrete steps, throughout the thickness of the thin film structure, or may alternately vary in a continuous manner. This non-discrete variation in thickness may be referred to as a “continuous gradation in thickness” for the layers in the thin film structure, and may help widen the operating wavelength range of the thin film structure performance. For the purposes of this document, it will be understood that a “quarter-wave” layer may be a quarter-wave at a particular wavelength in a range, and that the particular wavelength may vary discretely or continuously from the viewer side of the thin film structure to the absorber side of the thin film structure. For simplicity, we use the “H” and “L” notation commonly used in thin film analysis, keeping in mind this variation in thickness.

For light polarized parallel to that from the projector, at low angles of incidence, the thin film stack appears as Light-Scattering Layer |LHLHLHL . . . LHL| Absorber, or Light-Scattering Layer |(LH)ⁿL| Absorber, where “n” is a large integer, such as 100, 150, 200, 250, 300, 350, 400, 450, 500 or any suitable value. Such a thin film stack has a high reflectivity, which is desirable.

For light polarized perpendicular to that from the projector, at low angles of incidence, the thin film stack appears as Light-Scattering Layer |LLLL . . . LLL| Absorber, or Light-Scattering Layer |L²ⁿ⁺¹| Absorber. The light-scattering layer may have a refractive index roughly matched to that of the “L” material, such as 1.51, so that the thin film structure 93 may have a relatively low reflectivity, which is also desirable.

At relatively high angles of incidence, for the plane of incidence parallel to the polarization state (see top left of FIG. 10), light from the projector enters the screen with p-polarization. There is a condition for p-polarized light, where at a particular angle of incidence known as “Brewster's angle”, a reflection from an interface may be minimized or reduced. For p-polarized light propagating in the thin film structure 93 with an orientation near this Brewster's angle condition, the power reflectivity from each interface is reduced or minimized, so that the constructive interference among these reduced surface reflections is also reduced. This Brewster's angle condition is completely or approximately satisfied for light polarized parallel to that of the projector, with a high angle of incidence on the screen.

The actual Brewster's angle inside the thin film structure 93 may be calculated as follows. For p-polarized light traveling inside the “L” layer, the propagation angle (with respect to the substrate surface normal) that satisfies the Brewster's angle condition is sin⁻¹ (1.51/1.62), or about 43 degrees. For p-polarized light traveling inside the “H” layer, the propagation angle that satisfies the Brewster's angle condition is sin⁻¹ (1.62/1.51), or about 47 degrees.

Note that for both of these layers, the product of the refractive index and the sine of the propagation angle (that produces a Brewster's angle effect), n sin θ, is about 1.10. This value is larger than 1, which means that if the thin film structure 93 were used with a purely planar film/air interface, i.e. explicitly excluding the light scattering layer 11, then light incident from air would not be able to achieve the Brewster's angle condition inside the thin film structure 93, even at grazing incidence.

By placing the light-scattering layer between air incidence (the viewer) and the thin film structure 93, which effective gives the air incidence a higher effective refractive index than 1, such as 1.18, 1.30 or any other suitable value, we may achieve the Brewster's angle effect inside the thin film structure for air-incident angles of sin⁻¹ (1.10/1.18)=69 degrees, sin⁻¹ (1.10/1.30)=58 degrees, or any other suitable value.

In mathematical terms, we may calculate analytically the value of (n sin θ) for a ray that satisfies the Brewster's angle condition at an interface between isotropic materials having refractive indices n_{A} and n_{B}, and find that it equals

$$\frac{1}{\sqrt{\frac{1}{{n}_{A}^{2}} + \frac{1}{{n}_{B}^{2}}}} .$$

If the above calculated value is greater than 1, then the Brewster's angle condition cannot be satisfied for any rays entering the interface from a purely planar interface that has air as its incident medium. In other words, if the light-scattering layer 11 were removed from the screen, then none of the rays that entered the thin film structure 93 from air would satisfy the Brewster's angle condition in the thin film structure 93, if the above calculated quantity is greater than 1.

If the above calculated value is less than the effective incident refractive index supplied by the light-scattering layer 11, then there will be certain rays from air incidence that pass through the light-scattering layer 11 that satisfy the Brewster's angle condition inside the thin film structure 93. In other words, the Brewster's angle condition inside the thin film structure 93 may be accessible from air incidence, providing that the light-scattering layer 11 is used and provides an effective incident refractive index that exceeds the calculated value above.

Note that the above expression for (n sin θ) applies only to isotropic media, but is a ballpark approximation for birefringent media as well. Birefringent media may see Brewster's angle effects that depend on the z-refractive indices, in addition to the x- and y-refractive indices, and the expressions that predict the angles at which these effects may occur is therefore more complicated than the corresponding expression for isotropic media given above.

The calculation of Brewster's angle(s) in birefringent media is performed in the journal article titled, “Giant Birefringent Optics in Multilayer Polymer Mirrors”, written by Michael F. Weber, Carl A. Stover, Larry R. Gilbert, Timothy J. Nevitt and Andrew J. Ouderkirk, found in the journal Science, Vol. 287, No. 5462, pp. 2451-2456, dated 31 Mar. 2000. This journal article is incorporated by reference in its entirety.

In general, numerical calculation of Fresnel reflection coefficients for p- and s-polarizations as a function of incident angle may be more useful to a designer than a direct calculation of a Brewster's angle. These amplitude reflection coefficients may be calculated as described in the following paragraphs.

We refer to the geometry of FIG. 4, in which a multilayer optical film inside the screen 10, and calculate the Fresnel reflection coefficients for an interface between materials denoted as “1” and “2”. Either or both of material “1” and “2” may be birefringent, with optic axes that lie along the x, y, and/or z axes. Material “1” has refractive indices n₁ₓ, n_{1y} and n_{1z}, for electric field vectors oriented in the x, y and z directions, respectively. Likewise, material “2” has corresponding refractive indices n₂ₓ, n_{2y} and n_{2z}. For an isotropic incident medium having a refractive index n₀ (typically, 1.0 for air incidence) an incident angle sin θ₀, and incidence in the y-z plane (see beams 41-44 in FIG. 4), the Fresnel reflection coefficient for p-polarized light (see beams 41 and 42) is

$${r}_{p} = \frac{( {n}_{2 z} {n}_{2 y} \sqrt{{n}_{1 z}^{2} - {n}_{0}^{2} {sin}^{2} {θ}_{0}} - {n}_{1 z} {n}_{1 y} \sqrt{{n}_{2 z}^{2} - {n}_{0}^{2} {sin}^{2} {θ}_{0}} )}{( {n}_{2 z} {n}_{2 y} \sqrt{{n}_{1 z}^{2} - {n}_{0}^{2} {sin}^{2} {θ}_{0}} + {n}_{1 z} {n}_{1 y} \sqrt{{n}_{2 z}^{2} - {n}_{0}^{2} {sin}^{2} {θ}_{0}} )}$$

and the Fresnel reflection coefficient for s-polarized light (see beams 43 and 44) is

$${r}_{s} = \frac{( \sqrt{{n}_{1 x}^{2} - {n}_{0}^{2} {sin}^{2} {θ}_{0}} - \sqrt{{n}_{2 z}^{2} - {n}_{0}^{2} {sin}^{2} {θ}_{0}} )}{( \sqrt{{n}_{1 x}^{2} - {n}_{0}^{2} {sin}^{2} {θ}_{0}} + \sqrt{{n}_{2 x}^{2} - {n}_{0}^{2} {sin}^{2} {θ}_{0}} )}$$

For light incident in the x-z plane (see beams 45-48), the values of nₓ and n_{y} are exchanged in the above two equations. Values for the Fresnel amplitude reflectivities rₚ and rₛ for a particular interface may be summed in a known manner to produce a full thin film amplitude reflectivity, which may then be multiplied by its complex conjugate to form a power reflectivity. In general, when the Brewster's angle inside the film is accessible from air incidence, then p-polarized light incident on the viewing side of the screen at at least one incident angle experiences a reduced reflectivity due to Brewster's angle effects at interfaces between the alternating first and second layers.

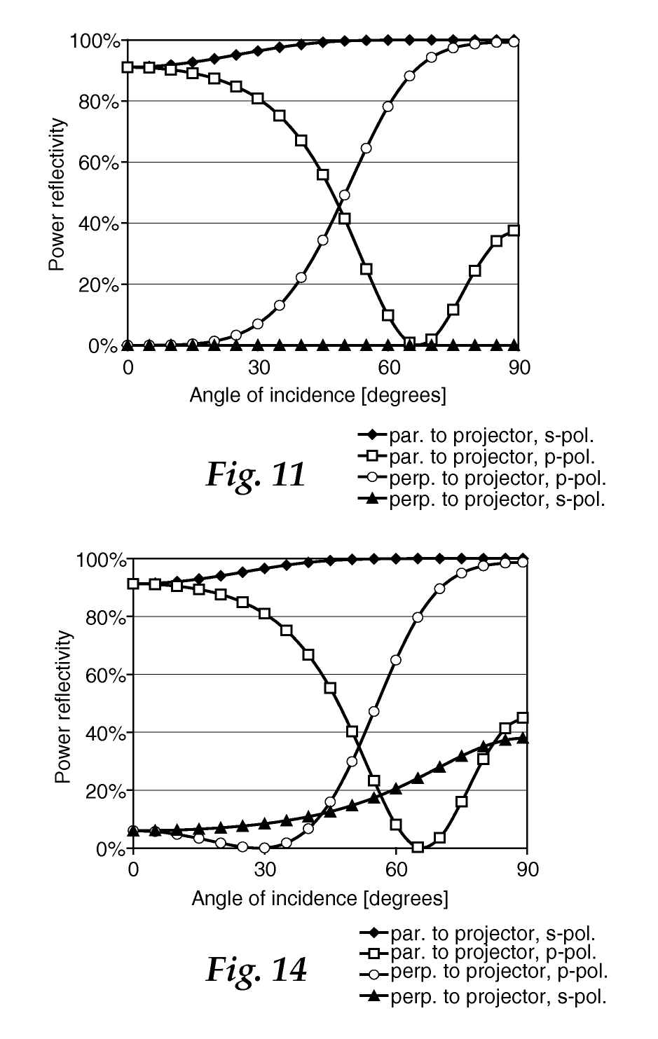

The modeled performance of the thin film structure 93 of FIGS. 9 and 10 is shown in FIG. 11, for 700 layers and a light-scattering layer 11 that has an effective incident refractive index of 1.2. The four curves are plots of power reflectivity as a function of incident angle in air (analogous to angle 63 in FIG. 6). From top-to-bottom in the legend, the curves correspond to beams 47/48, 41/42, 45/46 and 43/44 in FIG. 4; this correspondence holds for all the plotted results in this document. At low angles of incidence, the two topmost curves are for the polarization state parallel to that of the projector, and a high power reflectivity of about 91% is expected. At low angles of incidence, the two lower curves are for the polarization state perpendicular to that of the projector, and a very low power reflectivity is predicted, meaning that most of this light is transmitted through the thin film structure 93 to the absorber 14. At higher angles of incidence, the p-polarized curve for the polarization state parallel to that of the projector drops to a very low value around the region of Brewster's angle.

Note that there are two curves each for the polarization states perpendicular and parallel to that of the projector, with one for s-polarization and one for p-polarization. These four curves cover the complete range of polarization states for this system, and cover all the exemplary cases shown in FIG. 4. In practice, if the quarter-wave stack has enough layers, the two curves for parallel to the projector both start at a sufficiently high level, with s-polarization (beams 47/48 in FIG. 4) remaining high throughout and p-polarization (beams 41/42) dropping to a low levels near Brewster's angle. For the polarization state perpendicular to that of the projector, the s-polarized case (beams 43/44) remains at or near zero for all angles of incidence. The fourth curve, perpendicular to the projector, p-polarization, (circles in FIG. 11; beams 45/46 in FIG. 4), is difficult to control explicitly; for many applications, having this curve remain low at small angles of incidence may provide sufficient performance from the screen. In practice, this fourth curve may provoke a choice in how the screen is used, such as a choice between reducing the effects of an overhead light or reducing the effects of windows or light to the side of the screen.

The following is a physical explanation for the difficulty in controlling this fourth curve (for p-polarized light that is polarized perpendicular to the projector polarization; for beams 45/46 in FIG. 4). At low angles of incidence, the electric field vector is oriented largely in the plane of the thin film structure. The light interacts primarily with one of the in-plane refractive indices, with little interaction with the out-of-plane refractive index. Using the geometry shown in FIG. 4, beam 45 is incident in the x-z plane with its polarization oriented along x. Inside the thin film structure, the beam primarily sees nₓ, with little interaction with n_{z} and no interaction at all with n_{y}. However, at high angles of incidence (beam 46), the electric field vector has a substantial out-of-plane component, in addition to the in-plane component. Inside the thin film structure, the high-incident-angle beam sees substantial interaction with n_{z} as well as nₓ. Because the layers of the thin film structure may be refractive-index matched in nₓ (leftmost column in element 93 in FIG. 9 and rightmost column in element 93 in FIG. 10) but not n_{z} (middle column in both FIGS. 9 and 10), there may be sizable Fresnel reflections that arise at the layer interfaces, caused by the n_{z} mismatches from adjacent layers.

Note the rising reflectivity at high incident angles arises for p-polarized light, with the polarization being perpendicular to that of the projector (the circles in FIG. 11, and beams 45/46 in FIG. 4). An analogous effect, but with decreasing reflectivity at high incident angles, occurs for p-polarized light with the polarization being parallel to that of the projector (the squares in FIG. 11, and beams 41/42 in FIG. 4). Both of these effects are tethered together by the physics of the n_{z} reflections, with a good effect (R for beam 42 being lower than R for beam 41) having an analogous, inevitable, undesirable effect (R for beam 46 being higher than R for beam 45) at comparable incident angles.

Because it may be difficult to sufficiently reduce the reflectivity for p-polarization with the polarization perpendicular to that of the projector at high incident angles, it may be beneficial for the optical system to remove the source of such rays. For instance, in a typical room, there may be ambient light caused by overhead room lights and windows off to the side of the projector. Depending on the orientation of the projector polarization, the source of these rays (see beam 46) may be either the overhead room lights or the windows. If one of these two may be controlled, such as by blocking the window or turning off the room lights, then the polarization of the projector may be chosen so that the other source of ambient light may have a reduced reflectivity from the screen (beam 42).

In many cases, it is difficult to control the amplitude of these n_{z} reflections, but it is possible to control the incident angles at which they occur by adjusting the effective incident refractive index. This is explored more fully in the paragraphs that follow.

Note that if the light-scattering layer, which in FIG. 11 raises the effective incident refractive index from 1 to 1.2, were removed, the x-axis of the curves would be adjusted so that the 90-degree mark would fall roughly where the 56-degree mark is in FIG. 11.

Without the light-scattering layer, the thin film structure 93 would not be able to achieve the performance at the rightmost edge in FIG. 11 (beyond sin⁻¹ (1/1.2), or 56 degrees), because no air-incident light would be physically able to satisfy the Brewster's angle condition inside the thin film structure 93. Note that in general, if the high-index material “H” has negative birefringence, where the out-of-plane refractive index n_{z} is larger than the in-plane refractive indices nₓ and n_{y}, then the Brewster's angle between the “H” and “L” layers may be accessible from air, without necessarily using a structure that raises the incident refractive index.

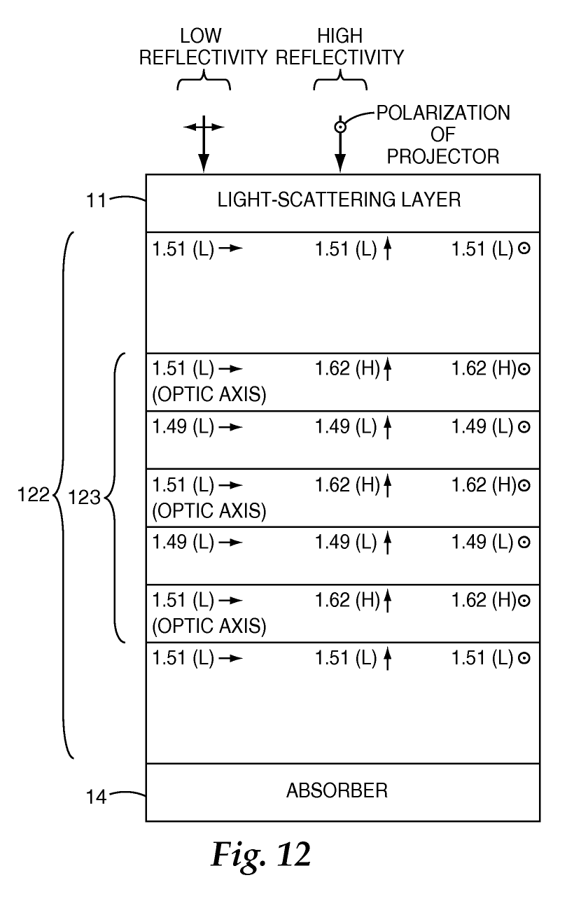

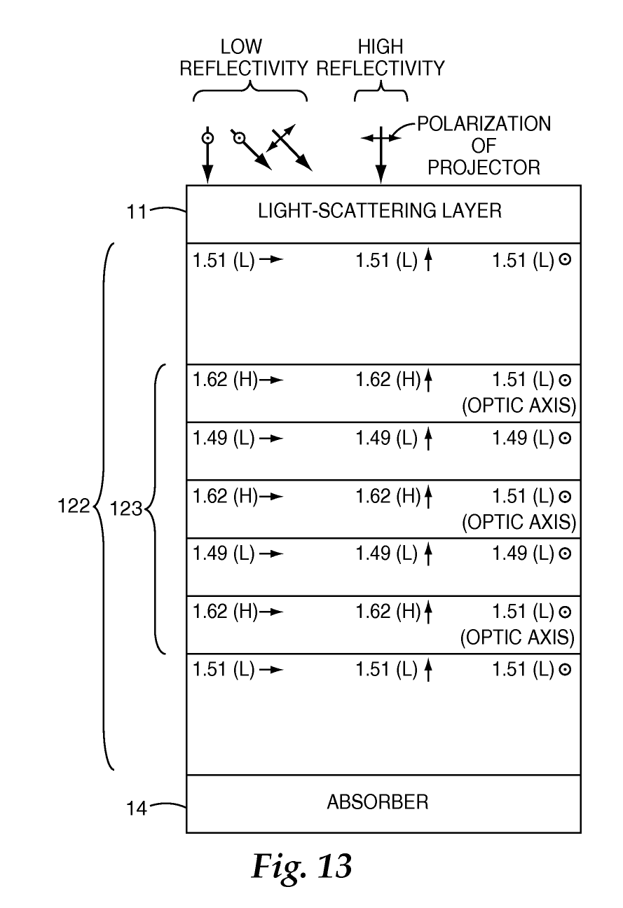

FIGS. 12 and 13 are schematic drawings of another thin film structure 123 and substrate 122. Compared to the thin film structure 93 of FIGS. 9 and 10, the thin film structure 123 has a mismatch between the “low” refractive indices of the non-birefringent layer (1.49) and the extraordinary refractive index of the birefringent layer (1.51). The thin film structure 123 also has 500 layers, compared to the 700 layers of the thin film structure 93 of FIGS. 9 and 10. The light-scattering layer in both thin film structures 93 and 123 provides an effective incident refractive index of 1.2.

The simulated performance of the thin film structure 123 is shown in FIG. 14. For the two curves corresponding to the polarization parallel to that of the projector, the reflectivity is comparable to the previous thin film structure 93. For the two curves corresponding to the polarization perpendicular to that of the projector, the reflectivity is slightly higher at normal incidence for both s- and p-polarizations, rising to near 10%.

The reflectivity is higher at all angles of incidence for s-polarization, rising to near 40% at grazing incidence. For p-polarization, the curve rises to a high reflectivity at a higher angle of incidence, compared to the comparable curve in FIG. 9, meaning that the thin film structure 123 may provide a slightly larger range of incident angles for which stray p-polarized light (polarized perpendicular to that of the projector) may be rejected.

In addition to the performance difference noted above, the thin film structure 123 may be cheaper to manufacture than structure 93, having only 500 layers, compared to the 700 layers of structure 93.

If the light-scattering layer were explicitly omitted from the screen of FIGS. 12 and 13, the performance would resemble that of FIG. 14, but with the x-axis of the curves would be adjusted so that the 90-degree mark would fall roughly where the 56-degree mark is in FIG. 11. For some applications, the thin film structure 123 and the screen including it may be functional without the light-scattering layer 11.

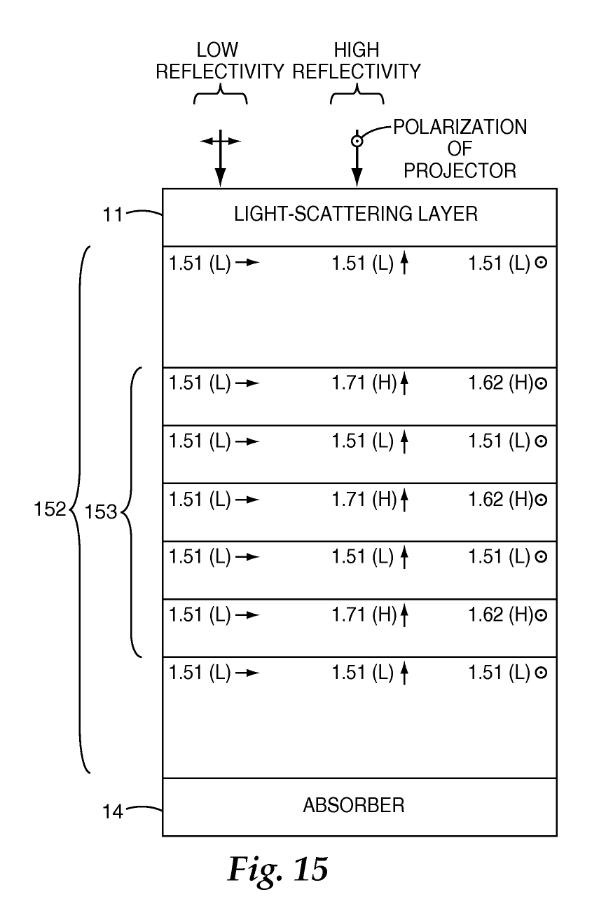

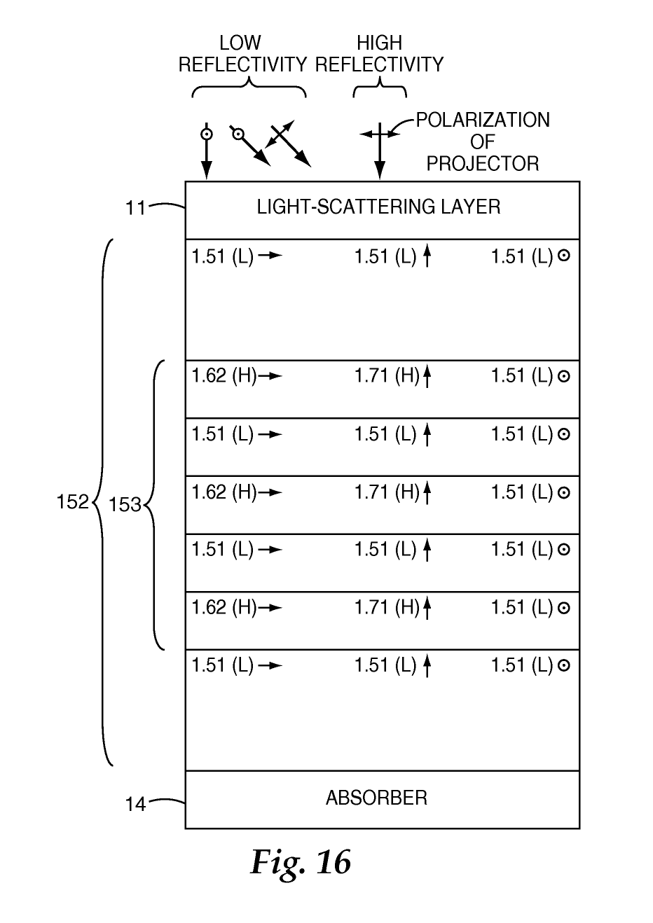

A third example of a thin film structure 153 and substrate 152 is shown in FIGS. 15 and 16. Here, the high-refractive-index layer has a biaxial birefringence, compared to the uniaxial birefringence in thin film structure 93 of FIGS. 9 and 10, which has only a single optic axis. As a result, the refractive indices corresponding to polarizations oriented in the x-y, y-z, and z-x planes are all different, with values of 1.52 and 1.62 being in-plane and 1.71 being out-of-plane.

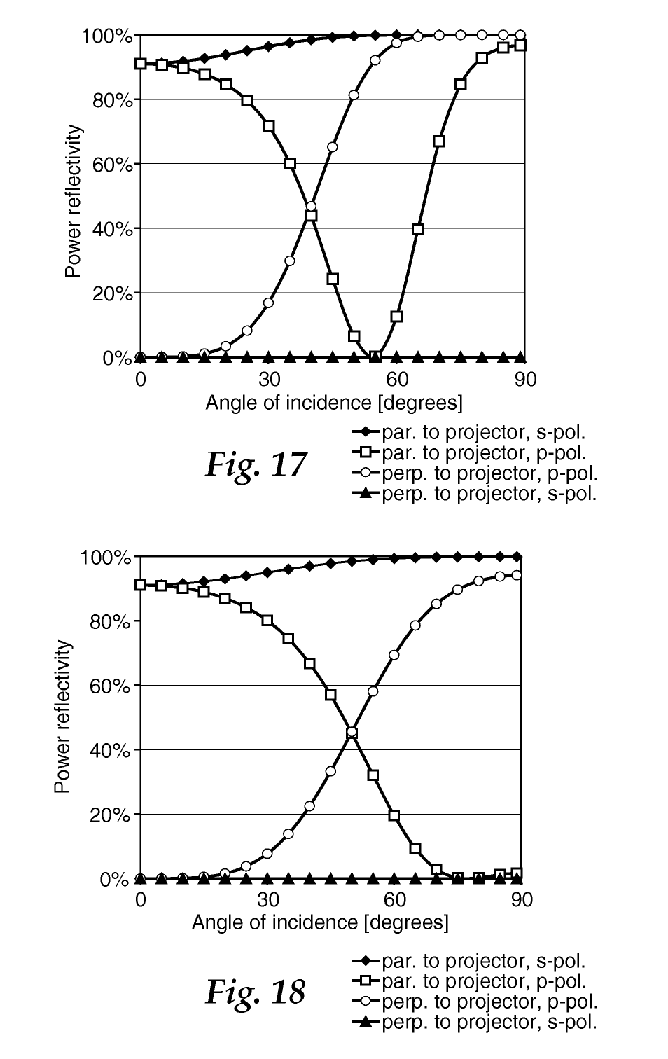

FIG. 17 is a plot of the performance of the thin film structure 153, for 700 layers and a light-scattering layer that increases the effective incident refractive index from 1 to 1.2. Note that the Brewster's angle effect occurs for a significantly lower incident angle than in the previous two examples. Here, the Brewster's angle effect appears for an incident angle around 55 degrees, compared to about 66-67 degrees for the previous two examples, shown in FIGS. 11 and 14.

For some applications, the Brewster's angle effect in FIG. 17 may actually occur at too low an angle, because the power reflectivity parallel to the projector with p-polarization (squares in FIG. 17) rises back to a high level at high angles of incidence. This unusually low Brewster's angle effect may be offset by removing the light-scattering layer 11, which raises the effective incident refractive index from 1 to 1.2. The light-scattering layer 11 may be replaced by a diffuser or another other suitable optical element that sufficiently diffuses the specular reflection of the projector, but not significantly raise the effective incident refractive index beyond 1.

Alternatively, the effect of this unusually low Brewster's angle may be reduced by including an air gap in the screen 10 between the light-scattering layer 11 and the thin film structure 13. Such an air gap would use total internal reflection to reflect away any rays that have a value of (n sin θ) greater than 1. This would limit the number of rays inside the thin film structure 13, but would not change the propagation angles inside the thin film structure for those rays that get through the air gap.

If the thin film structure 153 of FIGS. 15 and 16 is used without the light-scattering layer 11, the Brewster's angle effect is shifted to near-grazing incidence. Plots of the predicted power reflectivity are shown in FIG. 18. Note that at low angles of incidence, the two curves for polarization parallel to the projector have relatively a high power reflectivity of about 91% at normal incidence and 80% or higher for incident angles less than 30 degrees. The two curves for polarization perpendicular to the projector have relatively a low power reflectivity close to 0% at normal incidence and 10% or lower for incident angles less than 30 degrees. Stray light occurs at high angles of incidence, where two of the curves (squares, triangles) have a power reflectivity less than 20% for angles of incidence greater than 60 degrees. The other two curves are more difficult to control and rise to relatively high reflectivities at high angles of incidence.

As discussed above, reflections that arise from the mismatch in out-of-plane refractive indices may be troublesome at high incident angles (beam 46). One way to overcome this is discussed above, by either turning off the overhead room lights or blocking the side windows in the room. Another way to overcome this is to insert an optical component that absorbs the component of light polarized in the z-direction. If there is no electric field component polarized along z, then the mismatch in n_{z} will have a reduced effect. Such an optical component is discussed in the following paragraphs.

A so-called “E-polarizer” or “E-mode polarizer” is a relatively recent development in the field. Unlike a typical sheet polarizer, which absorbs only a transverse polarization component, an E-mode polarizer absorbs both the longitudinal polarization component and a transverse polarization component. In other words, for polarizers oriented along the x-y plane and passing the x-component of an incident beam, a typical sheet polarizer absorbs the y-component, while an E-mode polarizer absorbs both the y- and z-components. An E-mode polarizer placed in the screen 10, such as between the light-scattering layer 11 and the thin film structure 13, would absorb all light with its polarization perpendicular to that of the projector (“x” in FIG. 4), would absorb all light with its polarization along “z”, and would transmit all light with its polarization parallel to that of the projector (“y”). This would greatly reduce the rise in reflectivity at high incident angles for p-polarized light with its polarization perpendicular to that of the projector (beam 46 in FIG. 4).

The physics of such an E-mode polarizer is as follows. A material is produced that has a largely columnar structure, analogous to stacks of poker chips. The material is then mounted so that light would enter from the side of such a poker chip stack. Electrons are free to vibrate within each “chip” in the stack, leading to light absorption for the two polarization components that are parallel to the chip. Electrons are not free to vibrate from chip-to-chip, however, and light polarization along this chip-to-chip direction is transmitted by the polarizer. Using x,y,z notation, if the “poker chips” are resting on a table in the x-z plane and stacked up in the y-direction, then light traveling along x will have its x- and z-polarization components absorbed and its y-polarization component transmitted.

In some cases, such as in the cases described above, the film has high reflectivity for substantially all visible wavelengths at substantially all angles of incidence for an s-polarized light that is parallel to, for example, the projector light. For example, using the parameters from FIGS. 9 and 10, the long wavelength band edge of the reflector is at about 900 nm at normal incidence for substantially all visible light at substantially all angles of incidence. In some cases, the reflection bandwidth of the film is such that the average reflectance of the film decreases with increasing incident angles so that the reflectance of the film is less at higher angles of incidence and more at lower angles of incidence. In such cases, the light transmitted at higher angles of incidence can be absorbed resulting in higher screen contrast and resolution. P-polarized light that would normally be reflected by the film at high angles will also be transmitted by the film and absorbed by a light absorbing layer. For example, when the long wavelength band edge of the film is set at about 750 nm at normal incidence, the film transmits most of a red incident light at incident angles greater than 70 degrees in air. In such cases, when the film is immersed in a medium with an effective index of 1.2, then most of incident green and red light is transmitted at 70 degrees incidence. Other normal incidence band edges, such as about 650 nm, 700 nm, 800 nm or 850 nm, can be used to adjust the reflectivity of the projection screen as a function of incident angle.

It is instructive to summarize thus far. A projection system is disclosed, in which a screen may have improved rejection of ambient light by having a high reflectivity at low angles of incidence for a polarization parallel to that of the projector, a low reflectivity at high angles of incidence for a polarization parallel to that of the projector, and a low reflectivity at both low and high angles of incidence for a polarization perpendicular to that of the projector. In some applications, for p-polarized light polarized parallel to the projector, the power reflectivity is high at low angles of incidence and decreases to a low value at high angles of incidence. In some applications, for p-polarized light polarized perpendicular to the projector, the power reflectivity is low at low angles of incidence. In some applications, for s-polarized light polarized perpendicular to the projector, the power reflectivity remains low at all angles of incidence. In some applications, the screen includes a thin film structure that has alternating quarter-wave layers of isotropic and birefringent materials, which are refractive-index-matched for light polarized perpendicular to the projector, which form a high reflector at normal incidence for light polarized parallel to the projector, and which exhibit Brewster's angle effects for p-polarized light polarized parallel to the projector at high angles of incidence. The Brewster's angle effect may be reached by use of a light-scattering layer that increases the effective incident refractive index.

It is also instructive to summarize the eight beams shown in FIG. 4, along with their performance. Beams 41 and 48 represent light from the projector, and have a high power reflectivity R, due to the deliberate (transverse) refractive index mismatch between adjacent layers in the thin film structure. All other beams represent ambient light, and it is preferable to have their reflectivity values as low as possible; this is a design goal, and may not be achievable for all six ambient light beams. Beam 42 is designed to have a low R, and may rely on the Brewster's angle effects within the thin film stack to reduce R. Beams 43 and 45 have a low R, due to the deliberate (transverse) refractive index matching between adjacent layers. Beam 44 remains at or near the same low R as beam 43, due to the s-polarization of the beam and the fact that the beam does not see any out-of-plane refractive indices for any angles of incidence. Beam 46 may rise (undesirably) to a high R, due to the longitudinal refractive index mismatch between adjacent layers becoming problematic at high incident angles. Finally, beam 47 may have an (undesirably) high R, due to the absence of any Brewster's angle effects for s-polarization.

It is beneficial to discuss some of the various materials that may be used to produce the thin film structures shown in the figures and discussed above.

One suitable candidate for the birefringent material is syndiotactic polystyrene (sPS), which, depending on processing, may exhibit negative uniaxial birefringence with its optic axis within the plane of the layer. Note that a suitable uniaxial birefringent material having positive birefringence may be used as well. A brief discussion of a typical manufacturing process for sPS follows.

The birefringence properties of sPS films are studied by extruding sPS pellets into a cast web using a pilot plant extruder. Films are subsequently stretched using one of several stretcher, for a variety of sizes, temperatures and stretch rates. Once the films are stretched, the refractive indices of in-plane and normal directions may then be measured using a commercially available prism coupler, such as one manufactured by Metricon. Typical measured birefringence values are in the range of −0.01 to −0.11, after stretching. Some films are also subjected to a heat set at 230 C for one minute, with the effect of increasing the birefringence of some of the less-birefringent films to about −0.11.

Measured refractive index values agree well with the approximations used above of 1.51 and 1.62.

A suitable candidate for the non-birefringent material is an isotropic polymer having a refractive index in a range of about 1.48 to about 1.52. Some exemplary polymers for coextrusion with sPS are PMMA and polypropylene (both commonly available), Neostar Elastomer FN007 a copolyester commercially available from Eastman Chemical Company, Kingsport, Tennessee, Kraton G styrenic block copolymers 1657 and 1730 and Kraton 1901 available from Kraton Polymers LLC, Houston Tex., and polyolefins such as Exact 5181 and 8201 from ExxonMobil, Houston Tex., and Engage 8200, from Dow Chemical, Midland Mich. In cases where a birefringent material other than sPS is used for the high index material layers, materials other than the ones listed here may be chosen for the low index layers.

Note that the light-scattering layer 11 may optionally have a refractive index matched to either the ordinary (perpendicular to the optic axis) or extraordinary (parallel to the optic axis) refractive indices of the birefringent layer, the refractive index of non-birefringent layer. Alternatively, the refractive index of the light-scattering layer 11 may fall between the ordinary and extraordinary refractive indices. As a further alternative, the refractive index of the light-scattering layer 11 may not be matched to any other refractive index in the screen.

Other suitable birefringent and non-birefringent materials may be used as well. The examples provided herein are merely examples, and should not be construed as limiting in any way.

There are many applications for a screen 10 as described herein. For instance, the screen may be mounted in an office conference room as part of a permanent audio-visual setup. Or, the screen may be mounted outdoors, for displaying outdoor advertising. Alternatively, the screen may have automotive applications, such as for dashboards and the like. While the above cited applications are essentially permanent, so that the screen may be inflexible or immovably mounted, there are many applications where the screen may be flexible, conformable, repositionable, and/or removable.

The terms “flexible”, “conformable”, “removable” and “repositionable” are defined in U.S. Pat. No. 6,870,670, titled “Screens and methods for displaying information”, issued on Mar. 22, 2005 to Thomas R. Gehring, et al, which is incorporated by reference in its entirety herein.

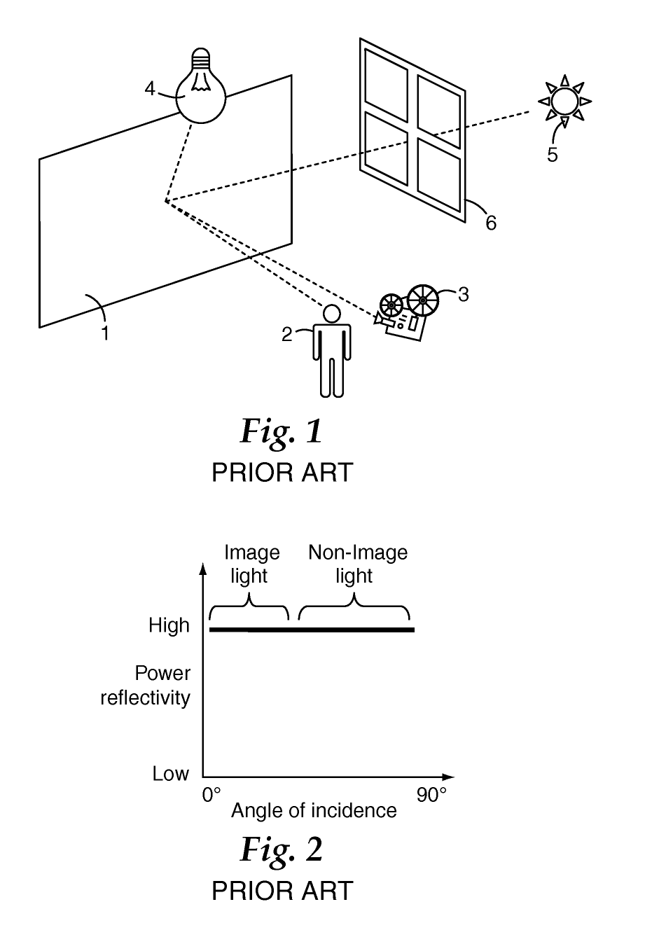

In some applications, the screen may be generally rectangular, as shown in FIG. 1. In other applications, the screen may be shaped as desired, and may take on any suitable footprint. The screen may be manufactured in a particular desired shape, or may be manufactured first, then cut into a desired shape.

In some applications, the screen may be mountable to a window or other surface, and/or may be adhered to a transference surface.

In some applications, the thin film structure may be tuned for one or more particular wavelengths or wavelength bands corresponding to the particular spectral components emerging from the projector. For instance, the thin film structure may have a high reflectivity for red, green and/or blue bands that correspond to the spectral components of red, green and/or blue light emitting diodes in the projector, and a low reflectivity for wavelengths outside the projection spectrum.

In some applications, the projector may emit light polarized along one direction for two colors (such as red and green, red and blue, or green and blue) and polarized along a perpendicular direction for the third color (such as blue, green, or red, respectively). In these cases, the thin film structure may accommodate the various polarizations appropriately by having at low angles of incidence, a high reflectivity for the projector polarization (one direction for two colors and the perpendicular direction for the third color) and a low reflectivity for the polarization orthogonal to the projector, plus a decreasing p-polarized reflectivity at high angles of incidence for light polarized parallel to that of the projector.

Item 1 is a front projection system, comprising:
a projector for projecting light to a screen, the light having a first polarization state;
a screen for receiving the light from the projector and reflecting light to a viewer, the screen comprising:
   an absorber; and
   a film disposed adjacent the absorber, between the absorber and the projector, the film having:
      a high power reflectivity at low angles of incidence for the first polarization state,
      a low power reflectivity at high angles of incidence for the first polarization state for p-polarized light,
      a low power reflectivity at low angles of incidence for a second polarization state perpendicular to the first polarization state, and
      a low power reflectivity at high angles of incidence for the second polarization state for s-polarized light.

Item 2 is the front projection system of item 1, wherein the low angles of incidence are less than about 30 degrees and the high angles of incidence are greater than about 65 degrees.

Item 3 is the front projection system of item 1, wherein the low power reflectivity is less than about 20% and the high power reflectivity is greater than about 80%.

Item 4 is the front projection system of item 1, the screen further comprising a light-scattering layer disposed adjacent the film, between the film and the projector, for directing light into a range of exiting reflected angles, the range including a specular reflection.

Item 5 is the front projection system of item 4, wherein the light-scattering layer comprises a plurality of partial spheres.

Item 6 is the front projection system of item 1, wherein the film comprises a plurality of alternating low refractive index and high refractive index layers, at least one of the low and high refractive index layers being birefringent.

Item 7 is the front projection system of item 6, wherein each birefringent layer has an optic axis oriented in the plane of the birefringent layer and parallel to the second polarization state; wherein the high refractive index layers are birefringent and have an ordinary refractive index and an extraordinary refractive index; wherein the ordinary refractive index is greater than the extraordinary refractive index, wherein the difference between the extraordinary refractive index and a refractive index of the low refractive index layers is less than the difference between the ordinary refractive index and the refractive index of the low refractive index layers.

Item 8 is the front projection system of item 1, wherein the projected light comprises red, green and blue spectral contributions; and wherein the film has a high power reflectivity at low angles of incidence for the first polarization state, for the red, green and blue spectral contributions, and a low power reflectivity at low angles of incidence for the first polarization state, for wavelengths outside the red, green and blue spectral contributions.

Item 9 is the front projection system of item 1, wherein the first polarization state comprises: a first linear polarization state at a first wavelength; and a second linear polarization state perpendicular to the first linear polarization state at a second wavelength, wherein the first and second wavelengths are between 400 nm and 700 nm and are different from each other.

Item 10 is a screen having a viewing side for receiving linearly polarized projected light with a projection polarization orientation from a projector and reflecting light to a viewer, comprising:
a light-scattering layer comprising a plurality of transmissive partial spheres and providing an elevated effective incident refractive index, the elevated effective incident refractive index depending at least on a depth and a refractive index of the transmissive partial spheres; and
a thin film structure disposed adjacent the light-scattering layer opposite the viewing side and including a plurality of alternating first and second layers;
wherein each first layer is birefringent and has a first refractive index, for light polarized along the projection polarization orientation and a second refractive index, for light polarized perpendicular to the projection polarization orientation; and
wherein each second layer is isotropic and has an isotropic refractive index, matched to the second refractive index and mismatched from the first refractive index;
so that p-polarized light incident on the viewing side of the screen at at least one incident angle experiences a reduced reflectivity due to Brewster's angle effects at interfaces between the alternating first and second layers.

Item 11 is the screen of item 10, further comprising an absorber disposed adjacent the thin film structure opposite the viewing side.

Item 12 is the screen of item 10, wherein the isotropic refractive index and the second refractive index differ by less than 0.03; and wherein the isotropic refractive index and the first refractive index differ by more than 0.09.

Item 13 is the screen of item 10, wherein the elevated effective incident refractive index is between about 1.1 and about 1.3.

Item 14 is the screen of item 10, wherein the first and second layers have an optical thickness of a quarter-wave at normal incidence for a wavelength between 400 nm and 700 nm.

Item 15 is the screen of item 10, wherein the first refractive index is an ordinary refractive index of the birefringent layer; and wherein the second refractive index is an extraordinary refractive index of the birefringent layer.

Item 16 is a method, comprising:
providing an array of partial spheres disposed on a substrate, the substrate having a surface normal;
directing an initial light ray onto the array of partial spheres at a non-zero initial incident angle with respect to the substrate surface normal;
refracting the initial light ray at the surface of the partial spheres to form an intra-sphere light ray;
transmitting the intra-sphere light ray through the partial spheres; and
transmitting the intra-sphere light ray into the substrate to form an intra-substrate light ray propagating at a substrate refracted angle with respect to the substrate surface normal;
wherein the substrate refracted angle is greater than a critical angle for the substrate in air.

Item 17 is the method of item 16, further comprising refracting the intra-sphere light ray at an interface between the partial spheres and the substrate.

Item 18 is the method of item 17, wherein the partial spheres and the substrate have different refractive indices.

Item 19 is the method of item 17, wherein the partial spheres and the substrate have equal refractive indices.

Item 20 is the method of item 16, further comprising:
directing a plurality of incident light rays onto the array of partial spheres at an incident angle with respect to the substrate surface normal, the plurality of incident light rays subtending a plurality of partial spheres;
refracting the plurality of incident light rays at the surface of the partial spheres to form a plurality of intra-sphere refracted rays;
transmitting the plurality of intra-sphere refracted rays through the partial spheres; and
transmitting the plurality of intra-sphere refracted rays into the substrate to form a plurality of intra-substrate refracted rays, the plurality of intra-substrate refracted rays propagating with a distribution of propagation angles with respect to the substrate surface normal;
selecting a representative propagation angle from the distribution of propagation angles; and
forming an effective incident medium refractive index given by a substrate refractive index, times the sine of the incident angle, divided by the sine of the representative propagation angle.

Item 21 is the method of item 20, further comprising:
predicting an arbitrary propagating angle inside the substrate of an arbitrary incident light ray on the array of partial spheres;
wherein the arbitrary incident light ray has an arbitrary incident angle with respect to the substrate surface normal;
wherein the arbitrary propagating angle is formed with respect to the substrate surface normal; and

wherein the sine of the arbitrary propagating angle is given by the effective incident medium refractive index, times the sine of the arbitrary incident angle, divided by the substrate refractive index.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1-10. (canceled)

11. A front projection system, comprising:
a projector for projecting light to a screen, the light having a first polarization state;
a screen for receiving the light from the projector and reflecting light to a viewer, the screen comprising:
an absorber; and
a film disposed adjacent the absorber, between the absorber and the projector, the film having:
a high power reflectivity at low angles of incidence for the first polarization state,
a low power reflectivity at high angles of incidence for the first polarization state for p-polarized light,
a low power reflectivity at low angles of incidence for a second polarization state perpendicular to the first polarization state, and
a low power reflectivity at high angles of incidence for the second polarization state for s-polarized light.

12. The front projection system of claim 11, wherein the low angles of incidence are less than about 30 degrees and the high angles of incidence are greater than about 65 degrees.

13. The front projection system of claim 11, wherein the low power reflectivity is less than about 20% and the high power reflectivity is greater than about 80%.

14. The front projection system of claim 11, the screen further comprising a light-scattering layer disposed adjacent the film, between the film and the projector, for directing light into a range of exiting reflected angles, the range including a specular reflection.

15. The front projection system of claim 14, wherein the light-scattering layer comprises a plurality of partial spheres.

16. The front projection system of claim 1, wherein the film comprises a plurality of alternating low refractive index and high refractive index layers, at least one of the low and high refractive index layers being birefringent.

17. The front projection system of claim 16,
wherein each birefringent layer has an optic axis oriented in the plane of the birefringent layer and parallel to the second polarization state;
wherein the high refractive index layers are birefringent and have an ordinary refractive index and an extraordinary refractive index;
wherein the ordinary refractive index is greater than the extraordinary refractive index,
wherein the difference between the extraordinary refractive index and a refractive index of the low refractive index layers is less than the difference between the ordinary refractive index and the refractive index of the low refractive index layers.

18. The front projection system of claim 11,
wherein the projected light comprises red, green and blue spectral contributions; and
wherein the film has
a high power reflectivity at low angles of incidence for the first polarization state, for the red, green and blue spectral contributions, and
a low power reflectivity at low angles of incidence for the first polarization state, for wavelengths outside the red, green and blue spectral contributions.

19. The front projection system of claim 11, wherein the first polarization state comprises:
a first linear polarization state at a first wavelength; and
a second linear polarization state perpendicular to the first linear polarization state at a second wavelength,
wherein the first and second wavelengths are between 400 nm and 700 nm and are different from each other.

20. A screen having a viewing side for receiving linearly polarized projected light with a projection polarization orientation from a projector and reflecting light to a viewer, comprising:
a light-scattering layer comprising a plurality of transmissive partial spheres and providing an elevated effective incident refractive index, the elevated effective incident refractive index depending at least on a depth and a refractive index of the transmissive partial spheres; and
a thin film structure disposed adjacent the light-scattering layer opposite the viewing side and including a plurality of alternating first and second layers;
wherein each first layer is birefringent and has a first refractive index, for light polarized along the projection polarization orientation and a second refractive index, for light polarized perpendicular to the projection polarization orientation; and
wherein each second layer is isotropic and has an isotropic refractive index, matched to the second refractive index and mismatched from the first refractive index;
so that p-polarized light incident on the viewing side of the screen at at least one incident angle experiences a reduced reflectivity due to Brewster's angle effects at interfaces between the alternating first and second layers.

21. The screen of claim 20, further comprising an absorber disposed adjacent the thin film structure opposite the viewing side.

22. The screen of claim 20,
wherein the isotropic refractive index and the second refractive index differ by less than 0.03; and
wherein the isotropic refractive index and the first refractive index differ by more than 0.09.

23. The screen of claim 20, wherein the elevated effective incident refractive index is between about 1.1 and about 1.3.

24. The screen of claim 20, wherein the first and second layers have an optical thickness of a quarter-wave at normal incidence for a wavelength between 400 nm and 700 nm.

25. The screen of claim 20,
wherein the first refractive index is an ordinary refractive index of the birefringent layer; and
wherein the second refractive index is an extraordinary refractive index of the birefringent layer.

26. A method, comprising:
providing an array of partial spheres disposed on a substrate, the substrate having a surface normal;
directing an initial light ray onto the array of partial spheres at a non-zero initial incident angle with respect to the substrate surface normal;
refracting the initial light ray at the surface of the partial spheres to form an intra-sphere light ray;
transmitting the intra-sphere light ray through the partial spheres; and
transmitting the intra-sphere light ray into the substrate to form an intra-substrate light ray propagating at a substrate refracted angle with respect to the substrate surface normal;
wherein the substrate refracted angle is greater than a critical angle for the substrate in air.

27. The method of claim 26, further comprising refracting the intra-sphere light ray at an interface between the partial spheres and the substrate.

28. The method of claim 27, wherein the partial spheres and the substrate have different refractive indices.

29. The method of claim 27, wherein the partial spheres and the substrate have equal refractive indices.

30. The method of claim 26, further comprising:
directing a plurality of incident light rays onto the array of partial spheres at an incident angle with respect to the substrate surface normal, the plurality of incident light rays subtending a plurality of partial spheres;
refracting the plurality of incident light rays at the surface of the partial spheres to form a plurality of intra-sphere refracted rays;
transmitting the plurality of intra-sphere refracted rays through the partial spheres; and
transmitting the plurality of intra-sphere refracted rays into the substrate to form a plurality of intra-substrate refracted rays, the plurality of intra-substrate refracted rays propagating with a distribution of propagation angles with respect to the substrate surface normal;
selecting a representative propagation angle from the distribution of propagation angles; and
forming an effective incident medium refractive index given by a substrate refractive index, times the sine of the incident angle, divided by the sine of the representative propagation angle.

31. The method of claim 30, further comprising:
predicting an arbitrary propagating angle inside the substrate of an arbitrary incident light ray on the array of partial spheres;
wherein the arbitrary incident light ray has an arbitrary incident angle with respect to the substrate surface normal;
wherein the arbitrary propagating angle is formed with respect to the substrate surface normal; and
wherein the sine of the arbitrary propagating angle is given by the effective incident medium refractive index, times the sine of the arbitrary incident angle, divided by the substrate refractive index.
